(19) United States
(12) Patent Application Publication
(10) Pub. No.: US 2021/0212347 A1
(43) Pub. Date: Jul. 15, 2021

(54) VACUUM MICROWAVE DRYING OF FOODS WITH PULSED ELECTRIC FIELD PRE-TREATMENT

(71) Applicant: EnWave Corporation, Delta (CA)

(72) Inventors: Guopeng Zhang, Delta (CA); Shafique Ahmad, Delta (CA); Erika Sandoval, Delta (CA); Braden Knights, Delta (CA)

(21) Appl. No.: 17/247,558

(22) Filed: Dec. 16, 2020

Related U.S. Application Data
(60) Provisional application No. 62/959,096, filed on Jan. 9, 2020.

(51) Int. Cl. A23L 3/54; A23B 7/015; A23B 7/04; A23B 7/045; A23B 7/01; A23B 7/028; A23B 7/06; A23L 3/01; A23L 3/015; A23L 3/32; A23L 3/365; A23L 3/48; A23L 5/10; A23L 19/00

(52) U.S. Cl. CPC A23L 3/54; A23V 2002/00; A23B 7/0441; A23B 7/045; A23B 7/01; A23B 7/028; A23B 7/06; A23L 3/01; A23L 3/015; A23L 3/32; A23L 3/365; A23L 3/485; A23L 5/10; A23L 19/03; A23B 7/015

(57) ABSTRACT

A method of making a porous, dehydrated food product comprises subjecting a food product to pulsed electric field treatment to form pores in the cell membranes of the food product, freezing the treated food product, and exposing the treated frozen food product to microwave radiation in a vacuum chamber at a pressure that is less than atmospheric and at which the boiling point of water is above 0° C., causing the frozen food product to thaw and water to evaporate to produce the porous, dehydrated product. The process is faster than freeze-drying and consumes less energy. The pulsed electric field treatment does not result in structural damage to the product, despite the thawing of the frozen product during the drying process.

### CROSS-REFERENCE TO RELATED APPLICATIONS

This application claims priority under 35 U.S.C. § 119 to provisional application Ser. No. 62/959,096, filed Jan. 9, 2020, herein incorporated by reference in its entirety.

### FIELD OF THE INVENTION

The invention pertains to methods of making dried food products having a porous structure, using pulsed electric field pre-treatment, freezing and vacuum microwave drying.

### BACKGROUND OF THE INVENTION

It is known in the food processing art to make dehydrated food products by means of vacuum microwave dehydration, also known as radiant energy vacuum (REV). Examples in the patent literature include WO 2014/085897 (Durance et al.), which discloses the production of dehydrated cheese pieces, and U.S. Pat. No. 6,312,745 (Durance et al.), which discloses the production of dehydrated berries. WO 2018/187851 (Durance et al.) discloses a vacuum microwave drying process in which a porous, crunchy, dehydrated food product is made by freezing a food product and exposing it to microwave radiation in a vacuum chamber at a vacuum pressure at which the boiling point of water is above 0° C., to thaw the frozen food product and evaporate liquid water from the thawed food product, resulting in a crunchy, dehydrated food product with a highly porous structure. It is also known in the food processing industry to dehydrate food products by freeze-drying, in which the process is conducted at very low pressures and temperatures and moisture is removed by sublimation. Freeze-drying can produce a high quality product but it has the disadvantages of being slow and expensive.

Pulsed electric field (PEF) treatment can be used to increase cell permeability of food products and thereby enhance dehydration. It can be used as a pre-treatment prior to freeze-drying, to reduce the energy required by the freeze-drying process. See, for example, Henry Jaeger et al., “PEF Enhanced Drying of Plant Based Products,” Stewart Postharvest Review, September 2012; and Zhenyu Liu et al, “Influence of Pulsed Electric Field Pretreatment on Vacuum Freeze-dried Apples and Process parameter Optimization,” Advance Journal of Food Science and Technology, 13(6): 224-235, 2017. However, it is also known that PEF treatment results in undesirable structural damage in freeze-thawed food products, which can deteriorate the quality of the thawed product: Jaeger et al., supra, at page 4.

The food processing industry has long been searching for a suitable drying method to replace the current freeze-drying process, while reducing the drying time and energy consumption and improving the colour- and flavour-retention of the dried food products.

### SUMMARY OF THE INVENTION

The present inventors have discovered that food products can be dehydrated by means of a process which includes pre-treatment with PEF, freezing, and drying in a vacuum microwave chamber under conditions in which the product is thawed in the vacuum chamber and liquid water is removed by evaporation, resulting in a product that is superior to a freeze-dried product. The process is much faster than freeze-drying and consumes less energy. The PEF in conjunction with vacuum microwave treatment does not result in structural damage to the product, despite the thawing of the frozen product during the drying process, which is believed to be due to the thawing being carried out under vacuum.

The invention provides a method of making a porous, dehydrated food product, comprising: (a) subjecting a food product to pulsed electric field treatment to form pores in cell membranes of the food product, (b) freezing the treated food product produced in step (a), and (c) exposing the frozen food product produced in step (b) to microwave radiation in a vacuum chamber at a pressure that is less than atmospheric and at which the boiling point of water is above 0° C., causing the frozen food product to thaw and water to evaporate from the thawed food product to produce the porous, dehydrated food product.

Further aspects of the invention and features of specific embodiments are described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A, 1B and 1C are photographs of carrot slices processed in accordance with the procedures of Example 7 (freeze-drying), Example 6 (vacuum microwave drying without PEF pre-treatment) and Example 5 (PEF pre-treatment followed by vacuum microwave drying), respectively.

FIGS. 2A, 2B and 2C are photographs of baby carrots which are (a) fresh, (b) subjected to PEF pre-treatment and freezing, and (c) further subjected to vacuum microwave drying in accordance with Example 8, respectively.

FIGS. 3A and 3B are photographs of baby carrots (a) after processing by vacuum microwave drying only in accordance with Example 9, and (b) after processing by PEF pre-treatment, freezing and vacuum microwave drying in accordance with Example 8, respectively.

FIG. 4 is a graph showing the rehydration ratios measured over time for each of PEF pre-treated and vacuum microwave dried (PEF-VMD) carrot slices, vacuum microwave dried without PEF pre-treatment (VMD) carrot slices, and freeze-dried (FD) carrot slices, in accordance with Example 11.

### DETAILED DESCRIPTION

The method of the invention begins with a raw food product such as a vegetable, fruit, or meat and produces from it a porous, dried food product, intended as a shelf-stable snack food. Examples of suitable food products are carrots, strawberries, grapes, grape tomatoes, mangoes, green peas, broccoli, beetroot, apples, pears, chicken and ham.

In some embodiments of the method, the raw food product is first sliced. In other embodiments, the food product is not sliced before processing, for example where a relatively larger product is preferred. Blanching prior to drying is an optional step for vegetables, which improves the final taste, texture and/or color for some products. Cooking prior to drying is also an optional step for some vegetables, such as sweet potato, to remove the raw taste.

The raw food product is first subjected to PEF treatment. In this process, the food product is exposed to an external electric field, which permeabilizes the cell membranes of the product, creating pores in them. The PEF pre-treatment may be done by submerging the food product in water inside the PEF treatment chamber, and applying pulses of electric energy at a selected voltage level and for a selected duration. The energy applied per kg of food product is selected so as to produce the desired permeabilization. For example, the energy per kg of product may be in the range of 0.1 to 10 kJ/kg. The voltage level may be in the range of 20 to 30 kV. The pulse frequency is a function of the particular PEF machine used, for example a 2 Hz machine generates 2 pulses per second. The number of pulses applied in the process depends upon the selected energy per kg of product. As an example, at 30 kV voltage, with an 8 kg load in a water bath, each pulse provides 450 J of energy to the product.

An example of an apparatus that is suitable for carrying out the PEF pre-treatment in the process of the invention is a DIL PEF-Cellcrack III apparatus, supplied by Elea, of Quakenbruck, Germany.

The PEF pre-treated food product is then removed from the PEF treatment chamber and is subjected to freezing. This may be done using a low temperature freezer, for example at freezing temperatures in the range of −5 to −80° C., preferably lower than −20° C., until the pre-treated food product is completely frozen. The freezing forms ice crystals within the product and these crystals result in the formation of pores.

The frozen food product is subjected to drying by means of microwave radiation and reduced pressure in a vacuum microwave dehydrator. Importantly, the frozen food product is not allowed to thaw prior to vacuum microwave treatment. The reduced pressure in the vacuum chamber is set at a pressure at which the boiling point of water is above 0° C., for example an absolute pressure in the range of 5 to 100 Torr (0.67 to 13.3 kPa), alternatively 20 to 40 Torr (2.7 to 5.3 kPa). The boiling point of water at these pressures is 1° C. at 5 Torr, 22° C. at 20 Torr, 34° C. at 40 Torr, and 51° C. at 100 Torr. The food product rapidly thaws in the dehydrator under the vacuum microwave treatment, and evaporation of liquid water causes steam pressure to be created in the pores formed by the ice crystals, preventing the pores from collapsing. The dried food product is thus highly porous.

The step of vacuum microwave drying may be conducted in two stages having different conditions in order to optimize the drying conditions and quality of the product. For example, in the first stage, the microwave power level may be higher than in the second stage. In the first stage, higher power is used to achieve faster drying. Lower power is used in the second stage to avoid over-drying and excessive temperatures in dry portions of the load that may lead to dark or burned portions. Or, in the different stages, the drying time or the speed of rotation of the product basket (where a rotating basket is employed to tumble the product during drying) may be different. Likewise, more than two drying stages may be employed.

The food product is dried to the desired moisture level, for example to a moisture level less than 5 wt. %, or less than 3 wt. %. It will be understood that “drying” means that the moisture level is reduced to a desired level, not necessarily to zero. The desired moisture level depends upon the chemical composition of the particular food product; different foods exhibit a crispy texture at different final moisture contents. The radiation is then stopped, the pressure in the vacuum chamber is equalized with the atmosphere, and the porous, dehydrated food product is removed from the vacuum microwave dehydrator.

An example of a vacuum microwave dehydrator that is suitable for drying the frozen food product in the present invention is a resonant cavity-type microwave apparatus, as shown in WO 2009/049409 (Durance et al.), commercially available from EnWave Corporation of Delta, Canada, under the trademark nutraREV. Using this type of apparatus, the frozen food product is placed for drying in a cylindrical basket that is transparent to microwave radiation and has openings to permit the escape of moisture. The loaded basket is placed in the vacuum chamber with its longitudinal axis oriented horizontally. The pressure in the chamber is reduced. The microwave generator is actuated to radiate microwaves in the vacuum chamber and the basket is rotated within the vacuum chamber, about a horizontal axis, so as to slowly and gently tumble the food pieces. The rotation of the basket may be effected, for example, by means of rollers on which the basket is supported, or by means of a rotatable cage in which the basket is placed.

Another example of a microwave-vacuum dehydrator suitable for carrying out the step of drying is a travelling wave-type apparatus, as shown in WO 2011/085467 (Durance et al.), commercially available from EnWave Corporation under the trademark quantaREV. The frozen food product is fed into the vacuum chamber and conveyed across a microwave-transparent window on a conveyor belt while being subjected to drying by means of low pressure and microwave radiation. With this type of apparatus, the food pieces are dried while resting on a tray or the conveyor belt, and are not subjected to tumbling.

### EXAMPLES

### Example 1

Fresh jumbo carrots (Nante variety) were cleaned and rinsed with tap water. The carrots were subjected to PEF treatment using an DIL PEF-Cellcrack III apparatus, supplied by Elea, of Quakenbruck, Germany. Batches of 1 kg of whole carrots were submerged in 7 liters of water inside the PEF treatment chamber. PEF treatment was done at 30 kV, 9 pulses, 4.5 seconds total duration, to result in 0.5 kJ of energy per kg of product. The PEF-treated carrots were sliced to 6 mm thick slices before freezing at −20° C. overnight.

The frozen carrot slices were then subjected to vacuum microwave dehydration using a 2 kW nutraREV dehydrator, supplied by EnWave Corporation, of Delta, Canada. A 1300 g sample of the frozen carrot slices plus 2 wt. % vegetable oil were loaded into a polypropylene basket and dried at 25 Torr (3.3 kPa) of absolute pressure in the nutraREV dryer. Microwave energy was applied at 2000 W for 1650 seconds, followed by 1500 W for 1080 seconds, followed by 750 W for 1740 seconds. The dried carrot slices were then removed from the vacuum chamber. Their residual moisture content was less than 3 wt. %. 1.180 kg of water was evaporated out of the product. The total microwave energy output was 1.571 kWh. The average drying rate was 1.180 kg/1.571 kWh=0.75 kg/kWh. The dried carrot slices exhibited almost identical external and internal structure and texture to a conventionally freeze-dried product, but with more pronounced color and flavour, which is due to the much shorter drying time. The dried product had greater porosity than the products of Examples 3 and 4 below.

### Example 2

The procedures of Example 1 were repeated, with the exception that the PEF treatment was done using 44 pulses, 22 seconds total duration, to result in 2.5 kJ of energy per kg of product. The dried carrot slices exhibited almost identical external and internal structure, and texture to a conventionally freeze-dried product, but with more pronounced color and flavour, which is due to the short drying time. The dried product of Example 2 was found to have a softer texture than the dried product of Example 1.

### Example 3 (Control)

The procedures of Example 1 were repeated, with the exception that no PEF treatment was done before the vacuum microwave drying. The dried product of Example 3 was less porous, had a harder texture and showed greater shrinkage that the dried products of Examples 1 and 2.

### Example 4 (Freeze-Drying)

Fresh jumbo carrots (Nante variety) were cleaned and rinsed with tap water. The carrots were sliced and subjected to freeze-drying at a pressure of 0.009 Torr (1.2 Pa) and a temperature of −80° C. for 48 hours. It was observed that the carrot slices maintained their shape and size but lost their original colour, which faded significantly in the freeze-drying process.

### Examples 5 to 7

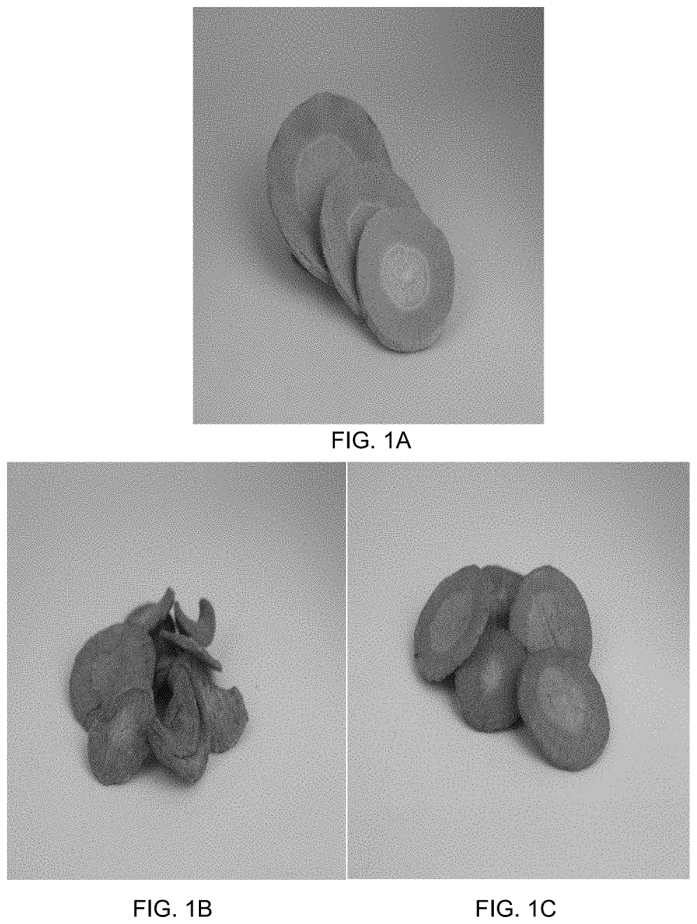

The procedures of Examples 2, 3 and 4 were repeated using carrots sliced to 3 mm thickness (rather than 6 mm) as Examples 5 (PEF pre-treatment and vacuum microwave drying), 6 (vacuum microwave drying without pre-treatment) and 7 (freeze-drying), respectively. Photographs of the dried products of Examples 5, 6 and 7 are shown in FIGS. 1C, 1B and 1A, respectively. The effect on the dimensions of the carrot slices when processed in accordance with Examples 5 to 7 is shown in Table 1.

TABLE 1

| Dimensions | Fresh | Example 5 | Example 6 | Example 7 |
|---|---|---|---|---|
| Diameter (mm) | 45.51 ± 9.9 | 29.83 ± 3.4 | 24.60 ± 4.52 | 44.84 ± 8.94 |
| Thickness (mm) | 3.00 | 2.38 ± 0.24 | 1.98 ± 0.28 | 3.00 |

### Example 8 (Baby Carrots)

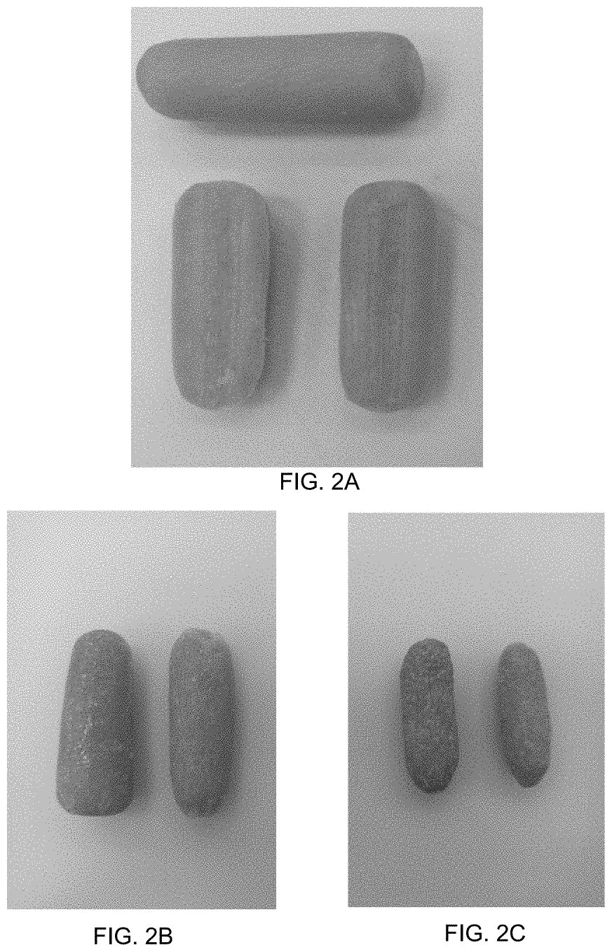

Fresh baby carrots were cleaned and rinsed with tap water. A 1 kg sample was subjected to PEF treatment in accordance with the procedure of Example 2. The PEF-treated baby carrots were frozen overnight at −20° C. The frozen baby carrots were then subjected to vacuum microwave dehydration in accordance with the procedure described in Example 1. Photographs of the fresh baby carrots, the pre-treated and frozen carrots, and the dried product are shown in FIGS. 2A, 2B and 2C, respectively.

### Example 9 (Control—Baby Carrots)

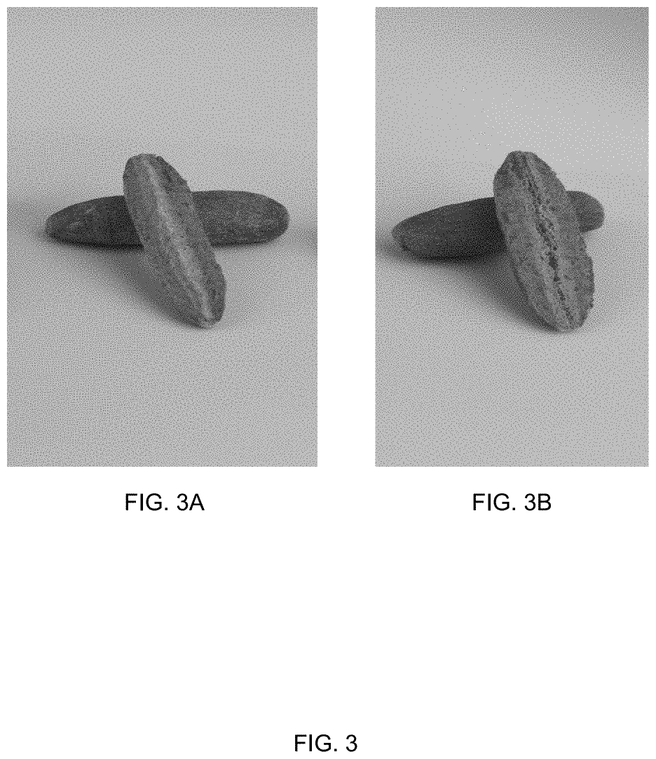

The procedures of Example 8 were repeated, with the exception that no PEF pre-treatment was done on the baby carrots before the vacuum microwave drying. A photograph of the dried product of Example 9 is shown in FIG. 3A. A further photograph of the dried product of Example 8 is shown in FIG. 3B.

### Example 10 (Freeze-Drying—Baby Carrots)

Fresh baby carrots were cleaned and rinsed with tap water. They were subjected to freeze-drying at a pressure of 0.009 Torr (1.2 Pa) and a temperature of −80° C. for 96 hours.

The effect on the dimensions of the baby carrots when processed in accordance with Examples 8 to 10 is shown in Table 2:

TABLE 2

| Dimensions | Fresh/Frozen | Example 8 | Example 9 | Example 10 |
|---|---|---|---|---|
| Length (mm) | 51.45 ± 3.29 | 42.39 ± 1.92 | 41.13 ± 2.7 | 51.41 ± 4.03 |
| Girth (mm) | 19.32 ± 1.57 | 12.32 ± 0.65 | 11.88 ± 0.95 | 18.5 ± 2.35 |

Based on the foregoing Examples, it was observed that the carrot slices and baby carrots that were freeze-dried (Examples 4, 7 and 10) retained their size and shape during freeze-drying but lost their original colour. The product texture was similar to Styrofoam. The freeze-drying process was time-consuming and energy intensive. It was further observed that carrot slices and baby carrots that were vacuum microwave dried without PEF pre-treatment (Examples 3, 6 and 9) retained much of their colour but shrank significantly during drying. The porosity of the dried product was less than the freeze-dried product. The carrot slices curled up and lost their original shape. It was further observed that the carrot slices and baby carrots that were processed according to the present invention using PEF pre-treatment and vacuum microwave drying (Examples 1, 2, 5 and 8) were superior to the product of the vacuum microwave process without PEF pre-treatment in terms of better colour retention, less shrinkage and no curling of slices. The product texture was very comparable to the freeze-dried product in terms of even size and distribution of porosity, and the melting-in-the-mouth quality, but superior to the freeze-dried product in terms of colour retention and not being spongy.

### Example 11 (Rehydration)

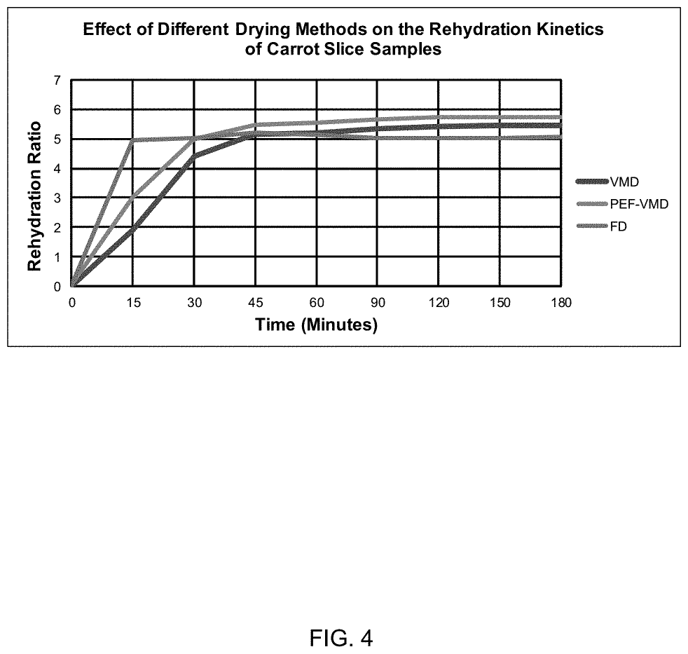

Samples of 1 to 2 grams of dehydrated carrot slices prepared in accordance with each of Example 2 (PEF pre-treatment and vacuum microwave drying), Example 3 (vacuum microwave drying without PEF pre-treatment) and Example 4 (freeze-drying) were rehydrated by immersion in beakers filled with 100 mL distilled water at room temperature. Slices were withdrawn from the water after 15 minutes, 30 minutes, 45 minutes, 1 hour, and thereafter every 30 minutes. After the specified soaking times, the hydrated slices were blotted free of excess surface moisture with paper towels and Kim wipes and weighed. The increase in the weight was taken as the amount of water absorbed. Rehydration measurements of carrot slices were continued until the difference between two consecutive weighings was insignificant. All the samples were studied in duplicate. The rehydration ratio of the different slices was determined using the following formula: Rehydration ratio=(weight of the rehydrated sample)−(solid weight of dry sample)/(solid weight of dry sample). FIG. 4 is a graph showing the rehydration ratios measured over time for each of PEF pre-treated and vacuum microwave dried (PEF-VMD) carrot slices, vacuum microwave dried without PEF pre-treatment (VMD) carrot slices, and freeze-dried (FD) carrot slices.

It was observed that the freeze-dried carrot slices rehydrated faster than the REV-dried samples, but the vacuum microwave dried samples (with or without PEF) demonstrated higher rehydration ratio (potential) than the freeze-dried control. The PEF-pretreated vacuum microwave dried sample had the highest rehydration ratio. This confirmed the visual structural observation of greater porosity of the PEF-pre-treated and vacuum microwave dried carrot slices, relative to the freeze-dried slices and the vacuum microwave dried without PEF pre-treatment slices.

As will be apparent to those skilled in the art in the light of the foregoing disclosure, many alterations and modifications are possible in the practice of this invention without departing from the scope thereof. Accordingly, the scope of the invention is to be construed in accordance with the following claims.

1. A method of making a porous, dehydrated food product, comprising:
(a) subjecting a food product to pulsed electric field treatment to form pores in cell membranes of the food product;
(b) freezing the treated food product produced in step (a); and
(c) exposing the frozen food product produced in step (b) to microwave radiation in a vacuum chamber at a pressure that is less than atmospheric and at which the boiling point of water is above 0° C., causing the frozen food product to thaw and water to evaporate from the thawed food product to produce the porous, dehydrated food product.

2. A method according to claim 1, wherein the pulsed electric field treatment comprises treatment at an electric field strength in the range of 20 kV to 30 kV.

3. A method according to claim 1, wherein the pulsed electric field treatment comprises treatment with electric pulses in the range of 0.1 to 10 kJ of electric energy per kg of the food product.

4. A method according to claim 1, wherein the pulsed electric field treatment comprises treatment with electric pulses in the range of 0.5 to 2.5 kJ of electric energy per kg of the food product.

5. A method according to claim 1, wherein the pulsed electric field treatment comprises treatment with a number of electric pulses in the range of 9 to 44 pulses.

6. A method according to claim 1, wherein the pulsed electric field treatment comprises treatment with electric pulses for a duration in the range of 4.5 seconds to 22 seconds.

7. A method according to claim 1, wherein step (b) is done at a temperature in the range of −80° C. to −5° C.

8. A method according to claim 1, wherein step (b) is done at a temperature of −20° C. or less.

9. A method according to claim 1, wherein step (c) is done in at least two stages and a microwave power level in the vacuum chamber is higher in a first stage than in a second stage.

10. A method according to claim 1, further comprising cooking the food product before step (c).

11. A method according to claim 1, further comprising blanching the food product before step (c).

12. A method according to claim 1, wherein step (c) is done at an absolute pressure in the range of 5 to 100 Torr.

13. A method according to claim 1, wherein step (c) is done at an absolute pressure in the range of 20 to 40 Torr.

14. A method according to claim 1, further comprising, during step (c) tumbling the food product in the vacuum chamber.

15. A method according to claim 1, wherein the porous, dehydrated food product has a moisture content less than 5 wt. %.

16. A method according to claim 1, wherein the porous, dehydrated food product has a moisture content less than 3 wt. %.

17. A method according to claim 1, wherein the food product is one of a vegetable, a fruit and meat.

18. A method according to claim 1, wherein the food product is carrots, strawberries, grapes, grape tomatoes, mangoes, green peas, broccoli, beetroot, apples, pears, chicken or ham.

19. A porous, dehydrated food product made by the method of claim 1.
